(19) United States
(12) Patent Application Publication
(10) Pub. No.: US 2026/0208846 A1
(43) Pub. Date: Jul. 23, 2026

(54) FLIGHT HEIGHT MAINTAINING DEVICE

(71) Applicant: MEISEI ELECTRIC CO., LTD., Isesaki-shi, Gunma (JP)

(72) Inventors: Kensaku SHIMIZU, Isesaki-shi, Gunma (JP); Takuji SUGIDACHI, Isesaki-shi, Gunma (JP); Naohiro SHINOZAKI, Isesaki-shi, Gunma (JP); Fusae ARAI, Isesaki-shi, Gunma (JP)

(21) Appl. No.: 18/715,142

(22) PCT Filed: Dec. 23, 2022
(86) PCT No.: PCT/JP2022/047640

§ 371 Date: May 31, 2024

(51) Int. Cl. B64B 1/62; B64B 1/64; B64D 45/00; G05D 1/48; G05D 109/20

(52) U.S. Cl. CPC B64B 1/62; B64B 1/64; B64D 45/00; G05D 1/48; G05D 2109/26

(57) ABSTRACT

An object is to increase the flight height of a flight height maintaining device including a balloon. A flight height maintaining device includes a balloon, a payload unit, a liquid discharging mechanism, and a controller. The balloon contains liquid and gas that generates buoyancy. The payload unit is attached to the balloon. The liquid discharging mechanism discharges the liquid in the balloon into air, and the controller controls an operation of the liquid discharging mechanism.

### TECHNICAL FIELD

The present invention is related to a flight height maintaining device for maintaining a flight height in the air.

### BACKGROUND ART

To maintain the flight height of a balloon released in the air, as described in Non-Patent Literature 1, ballast attached to the balloon may be dropped or gas filled in the balloon may be released. When the flight height of the balloon has decreased, it is possible to increase the flight height of the balloon by lightening the weight of the balloon by dropping the ballast. On the contrary, when the flight height of the balloon has increased, it is possible to decrease the flight height of the balloon, by releasing the gas from the inside of the balloon and decreasing buoyancy.

### CITATION LIST

### Non-Patent Literature

Non-Patent Literature 1: WADA Tadafuto, “Hikousen, Kikyu Gijutsu no Hatten” (“Development of Airship and Balloon Technology” in Japanese), Aeronautical and Space Sciences Japan, February 2000, Vol. 48, No. 553, pp. 59-64

### SUMMARY OF INVENTION

### Technical Problem

It is an object of the present invention to increase the flight height of a balloon by using means different from dropping ballast.

### Solution to Problem

A flight height maintaining device of the present invention includes a balloon, a payload unit, a liquid discharging mechanism, and a controller. The balloon contains liquid and gas that generates buoyancy. The payload unit is attached to the balloon. The liquid discharging mechanism discharges the liquid in the balloon into air, and the controller controls an operation of the liquid discharging mechanism.

The liquid discharging mechanism may comprise a liquid discharge pipe and a liquid pump. The liquid discharge pipe has a liquid suction port for sucking the liquid in the balloon. Upon receipt of a drive signal from the controller, the liquid pump generates suction force for causing the liquid discharge pipe to suck the liquid in the balloon. The liquid suction port may be positioned in a lower part of a region occupied by the liquid in the balloon.

The flight height maintaining device may be provided with a height measuring device that measures a flight height thereof. In that situation, the controller may bring the liquid discharging mechanism into operation, when the flight height measured by the height measuring device is lower than a prescribed height.

The flight height maintaining device may be provided with a gas discharging mechanism that discharges the gas in the balloon into the air, and the controller may control an operation of the gas discharging mechanism. The gas discharging mechanism may comprise a gas discharge pipe and a gas open/close valve. The gas discharge pipe guides the gas in the balloon into the air. Upon receipt of a drive signal from the controller, the gas open/close valve switches between a state in which a flow path for the gas in the gas discharge pipe is closed and a state in which the flow path is opened.

The gas discharge pipe is provided with a gas suction port for sucking the gas in the balloon, and when the gas and the liquid are contained in the balloon in contact with each other, the gas suction port may be positioned higher than an initial position of a liquid surface in the balloon. The flight height maintaining device may be provided with a height measuring device that measures a flight height thereof. In that situation, the controller may bring the gas discharging mechanism into operation, when the flight height measured by the height measuring device is higher than a prescribed height.

### ADVANTAGEOUS EFFECTS OF INVENTION

According to the present invention, by using the liquid discharging mechanism to discharge the liquid previously contained in the balloon into the air, it is possible to decrease the weight of the flight height maintaining device and to increase the flight height of the flight height maintaining device.

### BRIEF DESCRIPTION OF DRAWINGS

FIG. 1 is a schematic diagram of a flight height maintaining device.

FIG. 2 is a flowchart showing a process of adjusting a flight height of the flight height maintaining device.

FIG. 3 is a drawing showing a liquid discharge state of the flight height maintaining device.

FIG. 4 is a drawing showing a gas discharge state of the flight height maintaining device.

FIG. 5 is a drawing for explaining a modification example of the flight height maintaining device.

### DESCRIPTION OF EMBODIMENTS

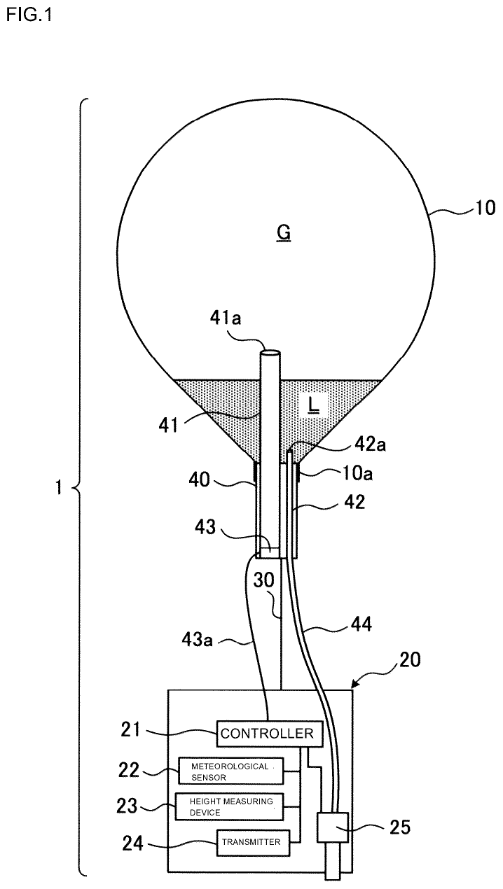

As shown in FIG. 1, a flight height maintaining device 1 includes a balloon 10, a payload unit 20, and a rope 30 connecting the balloon 10 and the payload unit 20 together. Gas G that generates buoyancy for the flight height maintaining device 1 and liquid L are contained inside the balloon 10. Further, the liquid surface of the liquid L is in contact with the gas G. The balloon 10 is formed by using a stretchable/contractible material, so that the size of the balloon 10 changes in accordance with contained amounts of the gas G and the liquid L.

The gas G has no limitation as long as the gas is able to generate the buoyancy for the flight height maintaining device 1, and it is acceptable to use helium gas or hydrogen gas, for example. As the liquid L, it is acceptable to use liquid (antifreeze liquid) that does not get frozen while the flight height maintaining device 1 is flying through the air; and as the antifreeze liquid, it is acceptable to use a water solution of an antifreeze agent, such as methanol, ethanol, or ethylene glycol.

Before the flight height maintaining device 1 is released in the air, the liquid L is contained in the balloon 10, together with the gas G. As described later, the liquid L is to be discharged to the outside of the balloon 10, for the purpose of increasing the buoyancy of the flight height maintaining device 1, and the amount of the liquid L contained in the balloon 10 in advance may be determined as appropriate. In this situation, the liquid L occupies a part of the internal space of the balloon 10. Further, to ensure that the flight height maintaining device 1 rises in the air even while the liquid L is contained in the balloon 10, the gas G in a desired amount may be contained in the balloon 10.

A plug 40 is attached to an opening tube 10a of the balloon 10. The plug 40 is used for bringing the inside of the balloon 10 into a hermetically sealed state, and a gas discharge pipe 41 and a liquid discharge pipe 42 are provided inside the plug 40.

The gas discharge pipe 41 is used for discharging the gas G present inside the balloon 10 to the outside of the balloon 10 (into the air). A gas suction port 41a is provided at the upper end of the gas discharge pipe 41, and the gas suction port 41a is positioned above the liquid surface of the liquid L contained in the balloon 10. When the flight height maintaining device 1 is to be released into the air, the liquid L in the predetermined amount is contained in the balloon 10 together with the gas G, while the position of the gas suction port 41a is set so that the gas suction port 41a is positioned above the liquid surface (an initial position) of the liquid L having been contained.

A gas open/close valve 43 is provided in a lower part of the gas discharge pipe 41. It is acceptable to use an electromagnetic valve, for example, as the gas open/close valve 43. Upon receipt of drive signals from a controller 21 (described later), the gas open/close valve 43 operates between a state (hereinafter, “closed state”) in which a flow path for the gas G in the gas discharge pipe 41 is closed and a state (hereinafter, “open state”) in which the flow path for the gas G in the gas discharge pipe 41 is opened.

While the gas open/close valve 43 is in the open state, it is possible to discharge the gas G present inside the balloon 10 to the outside of the flight height maintaining device 1 via the gas discharge pipe 41 because the pressure inside the balloon 10 is higher than the pressure outside the balloon 10. While the gas open/close valve 43 is in the closed state, it is possible to retain the gas G inside the balloon 10.

In this situation, the gas discharge pipe 41 and the gas open/close valve 43 described above constitute a gas discharging mechanism for discharging the gas G inside the balloon 10 into the air. Further, when the flight height maintaining device 1 is to be released into the air, the gas discharge pipe 41 may be used to have the gas G and the liquid L contained in the balloon 10. For example, by using the gas discharge pipe 41, it is possible to have the liquid L contained in the balloon 10 and to subsequently have the gas G contained in the balloon 10.

The liquid discharge pipe 42 is used for discharging the liquid L present inside the balloon 10 to the outside of the balloon 10 (into the air). A liquid suction port 42a is provided at the upper end of the liquid discharge pipe 42, and the liquid suction port 42a is positioned within the liquid L present inside the balloon 10. When the flight height maintaining device 1 is to be released into the air, the liquid L in the predetermined amount is contained in the balloon 10 together with the gas G, while the position of the liquid suction port 42a is set so that the liquid suction port 42a is positioned below the liquid surface (the initial position) of the liquid L having been contained. Further, in order to be able to discharge the liquid L in the balloon 10 as much as possible into the air, it is desirable to position the liquid suction port 42a in a lower part of the region occupied by the liquid L within the balloon 10.

The lower end of the liquid discharge pipe 42 is connected to one end of a connection pipe 44. The connection pipe 44 is disposed outside the plug 40. The other end of the connection pipe 44 is connected to a liquid pump 25 provided for the payload unit 20. Although the connection pipe 44 is connected to the liquid discharge pipe 42 in the present embodiment, the liquid discharge pipe 42 and the connection pipe 44 may be constructed integrally.

The liquid pump 25 operates by receiving a drive signal from the controller 21, while a lower end part of the liquid pump 25 is exposed to the outside of the flight height maintaining device 1 (the payload unit 20, in other words). While the liquid pump 25 is not in operation, the liquid L can be retained inside the balloon 10. Bringing the liquid pump 25 into operation generates suction force for causing the liquid discharge pipe 42 to suck the liquid L present inside the balloon 10. That is to say, the liquid L present inside the balloon 10 is sucked through the liquid suction port 42a and is discharged to the outside of the flight height maintaining device 1 (the payload unit 20, in other words) after passing through the liquid discharge pipe 42, the connection pipe 44, and the liquid pump 25. As a result, the amount of the liquid L present inside the balloon 10 decreases.

The position of the liquid suction port 42a may be determined as appropriate, and the liquid suction port 42a may be arranged in a position that makes it easy to discharge the liquid L present inside the balloon 10.

For example, in order to make it easy to discharge all the liquid L present inside the balloon 10, the liquid suction port 42a may be arranged at the same position as the upper end face of the plug 40.

The inside diameter of the liquid discharge pipe 42 (including the connection pipe 44) and the inside diameter of the gas discharge pipe 41 may be equal to each other, but one of the inside diameters may be larger than the other inside diameter. In the present embodiment, the inside diameter of the liquid discharge pipe 42 (including the connection pipe 44) is configured to be smaller than the inside diameter of the gas discharge pipe 41. This configuration makes it easy to finely adjust the discharge amount of the liquid L into the air.

Further, the liquid discharge pipe 42, the connection pipe 44, and the liquid pump 25 described above constitute a liquid discharging mechanism that discharges the liquid L in the balloon 10 into the air. Also, before the flight height maintaining device 1 is to be released into the air, the liquid discharge pipe 42 may be used to have the gas G and the liquid L contained in the balloon 10. For example, by using the liquid discharge pipe 42, it is possible to have the liquid L contained in the balloon 10 and to subsequently have the gas G contained in the balloon 10. As another example, it is possible to have the gas G contained in the balloon 10 by using the gas discharge pipe 41 and to also have the liquid L contained in the balloon 10 by using the liquid discharge pipe 42.

The payload unit 20 includes the controller 21, a meteorological sensor 22, a height measuring device 23, a transmitter 24, and the liquid pump 25. The controller 21 is electrically connected to the gas open/close valve 43 via a signal line 43a and controls driving of the gas open/close valve 43.

The meteorological sensor 22 measures meteorological elements such as atmospheric pressure, atmospheric temperature, humidity, and/or the like, and transmits measurement results to the controller 21. The height measuring device 23 measures a flight height of the flight height maintaining device 1 and transmits measurement results to the controller 21. As the height measuring device 23, a Global Positioning Sensor (GPS) may be used. The method for measuring the flight height of the flight height maintaining device 1 is not limited to the method using the GPS, and it is acceptable to use other publicly-known measuring methods. Upon receipt of a drive signal from the controller 21, the transmitter 24 transmits measurement information from the meteorological sensor 22 and the height measuring device 23 to a receiver (not shown) provided on the ground.

In the present embodiment, the meteorological sensor 22 is mounted on the payload unit 20; however, possible embodiments are not limited to this example. For instance, it is possible to mount, on the payload unit 20, a mobile communication device, an imaging device that images an object from the air and generates an image (a visible image or an infrared image), a radar that emits a radio wave from the air and measures the radio wave reflected by an object, and/or a relay device that receives a signal transmitted from a transmitting station on the ground and transmits the received signal to a receiving station on the ground.

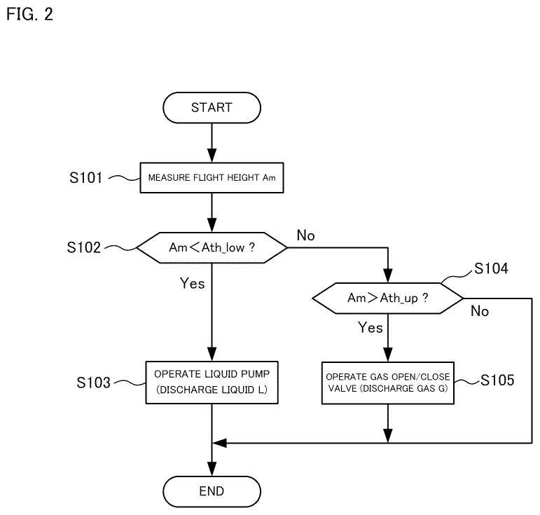

Next, a flight height adjusting process performed by the flight height maintaining device 1 will be described, with reference to the flowchart in FIG. 2.

The process shown in FIG. 2 is executed by the controller 21 in a prescribed cycle.

In step S101, the controller 21 measures a current flight height Am of the flight height maintaining device 1, by using the height measuring device 23.

In step S102, the controller 21 judges whether or not the flight height Am measured in the process in step S101 is lower than a lower limit height Ath_low. The lower limit height Ath_low is the lower limit value of the flight height allowed for the flight height maintaining device 1 to maintain a desired flight height. The lower limit height Ath_low may be determined in advance in accordance with a purpose of use of the flight height maintaining device 1. Information about the lower limit height Ath_low may be stored in a memory (not shown) provided for the controller 21.

When the flight height Am is lower than the lower limit height Ath_low, the process proceeds to step S103. On the contrary, when the flight height Am is equal to or higher than the lower limit height Ath_low, the process proceeds to step S104.

In step S103, the controller 21 operates the liquid pump 25 to discharge the liquid L present inside the balloon 10 to the outside of the balloon 10 (into the air). The controller 21 keeps the gas open/close valve 43 in the closed state so that the gas G in the balloon 10 will not be discharged into the air, when discharging the liquid L into the air.

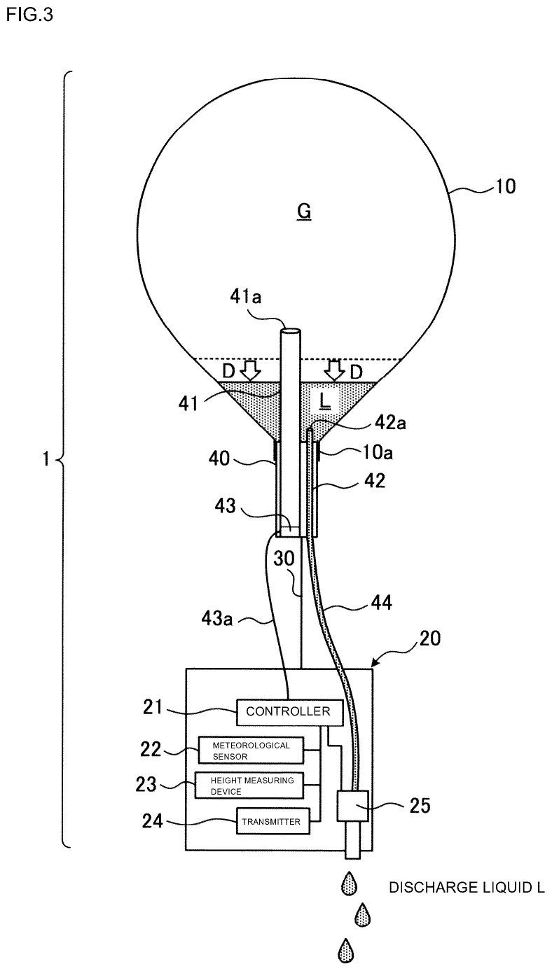

As a result, as shown in FIG. 3, the liquid L in the balloon 10 is taken into the liquid discharge pipe 42 through the liquid suction port 42a, sequentially passes through the liquid discharge pipe 42, the connection pipe 44, and the liquid pump 25 in the stated order, and is discharged to the outside of the flight height maintaining device 1. As a result of discharging the liquid L to the outside of the flight height maintaining device 1 (into the air), the liquid surface of the liquid L inside the balloon 10 falls in the direction of the arrows D shown in FIG. 3.

Although, in the present embodiment, the liquid pump 25 is provided for the payload unit 20 so as to discharge the liquid L from the lower part of the payload unit 20 as shown in FIG. 3, possible embodiments are not limited to this example. In other words, other configurations are also acceptable as long as it is possible to discharge the liquid L in the balloon 10 into the air. For example, it is acceptable to attach the liquid pump 25 to the plug 40 so as to discharge the liquid L into the air through the plug 40. In that situation, the liquid pump 25 may be connected to the controller 21 via a signal line (not shown) so that the liquid pump 25 may be operated by the controller 21.

As a result of discharging only the liquid L in the balloon 10 into the air, without discharging the gas G in the balloon 10, it is possible to decrease the weight of the flight height maintaining device 1 by the amount of the discharged liquid L and to thus increase the flight height Am of the flight height maintaining device 1. Consequently, the flight height Am of the flight height maintaining device 1 can be kept equal to or higher than the lower limit height Ath_low.

The discharge amount (hereinafter “liquid discharge amount”) QL when discharging the liquid L in the balloon 10 into the air may be determined as appropriate. The controller 21 is able to control the operating of the liquid pump 25 on the basis of the determined liquid discharge amount QL.

For example, when the process in step S103 is performed after the prescribed liquid discharge amount QL is determined in advance, it is possible to discharge the liquid L into the air by the prescribed liquid discharge amount QL. Further, the liquid discharge amount QL may be changed in accordance with a difference ΔA1 (ΔA1=Ath_low−Am) between the flight height Am and the lower limit height Ath_low. More specifically, when a correlation between differences ΔA1 and liquid discharge amounts QL is determined in advance, calculating a difference ΔA1 makes it possible to specify a liquid discharge amount QL corresponding to the difference ΔA1. Further, it is possible to discharge the liquid L into the air by the specified liquid discharge amount QL. The correlation between the differences ΔA1 and the liquid discharge amounts QL may be defined in such a manner that the larger the difference ΔA1 is, the larger the liquid discharge amount QL is.

In step S104, the controller 21 judges whether or not the flight height Am measured in the process in step S101 is higher than an upper limit height Ath_up. The upper limit height Ath_up is the upper limit value of the flight height allowed for the flight height maintaining device 1 to maintain a desired flight height. The upper limit height Ath_up is a height higher than the lower limit height Ath_low described above. The upper limit height Ath_up may be determined in advance in accordance with a purpose of use of the flight height maintaining device 1. Information about the upper limit height Ath_up may be stored in a memory (not shown) provided for the controller 21.

When the flight height Am is higher than the upper limit height Ath_up, the process proceeds to step S105.

On the contrary, when the flight height Am is equal to or lower than the upper limit height Ath_up, the process shown in FIG. 2 is ended without performing the process in step S103 or the process in step S105, because it means that the flight height Am is maintained at a height between the lower limit height Ath_low and the upper limit height Ath_up.

In step S105, the controller 21 operates the gas open/close valve 43 to discharge the gas G present inside the balloon 10 to the outside of the balloon 10 (into the air). When discharging the gas G into the air, the controller 21 stops driving the liquid pump 25 so that the liquid L in the balloon 10 will not be discharged into the air.

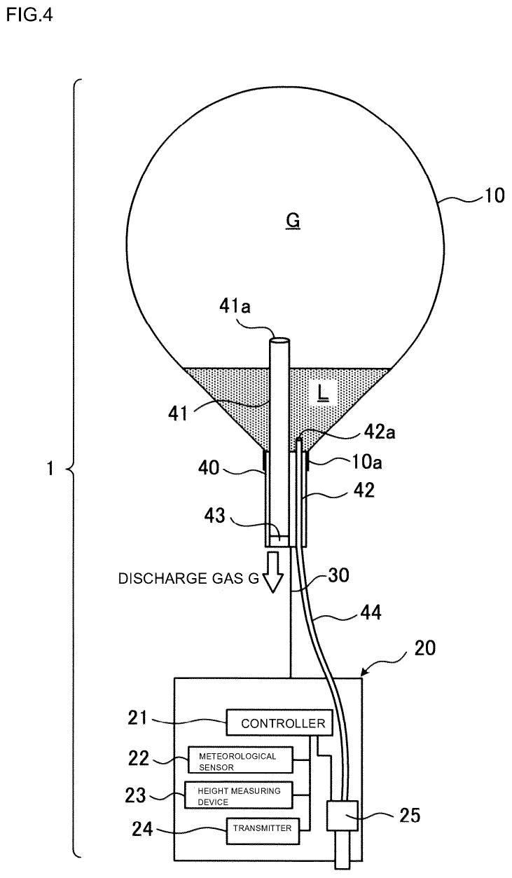

As a result, as shown in FIG. 4, the gas G in the balloon 10 is taken into the gas discharge pipe 41 through the gas suction port 41a, passes through the gas discharge pipe 41 and the gas open/close valve 43, and is discharged to the outside of the flight height maintaining device 1 (into the air). The signal line 43a is omitted from FIG. 4. As a result of discharging only the gas G in the balloon 10 into the air, without discharging the liquid L in the balloon 10, it is possible to decrease the buoyancy of the flight height maintaining device 1 by the amount of the discharged gas G and to thus decrease the flight height of the flight height maintaining device 1. Consequently, the flight height Am of the flight height maintaining device 1 may be kept equal to or lower than the upper limit height Ath_up.

The discharge amount (hereinafter “gas discharge amount”) QG when discharging the gas G in the balloon 10 into the air may be determined as appropriate. The controller 21 is able to control the operating of the gas open/close valve 43 on the basis of the determined gas discharge amount QG.

For example, when the process in step S105 is performed after the prescribed gas discharge amount QG is determined in advance, it is possible to discharge the gas G into the air by the prescribed gas discharge amount QG. On the other hand, in accordance with a difference ΔA2 (ΔA2=Am−Ath_up) between the flight height Am and the upper limit height Ath_up, the gas discharge amount QG may be changed. More specifically, when a correlation between differences ΔA2 and gas discharge amounts QG is determined in advance, calculating a difference ΔA2 makes it possible to specify a gas discharge amount QG corresponding to the difference ΔA2. Further, it is possible to discharge the gas G into the air by the specified gas discharge amount QG. The correlation between the differences ΔA2 and the gas discharge amounts QG may be defined in such a manner that the larger the difference ΔA2 is, the larger the gas discharge amount QG is.

In the present embodiment, by discharging the liquid L contained in the balloon 10 into the air, the flight height Am of the flight height maintaining device 1 is increased; however, possible embodiments are not limited to this example. More specifically, ballast (not shown) may be attached to the payload unit 20 and may be dropped from the payload unit 20 to increase the flight height Am of the flight height maintaining device 1 in addition to discharging the liquid L in the balloon 10 into the air. A mechanism for dropping the ballast (hereinafter, “ballast dropping mechanism”), it is acceptable to adopt any of publicly-known mechanisms as appropriate, and the controller 21 is capable of controlling operations of the ballast dropping mechanism.

In this situation, it is desirable to perform the process of discharging the liquid L in the balloon 10 into the air and the process of dropping the ballast with mutually-different timing. For example, it is possible to prioritize, at first, the process of dropping the ballast so that, after all the ballast has been dropped, the process of discharging the liquid L into the air is performed. In another example, it is possible to prioritize, at first, the process of discharging the liquid L into the air so that, when there is no more liquid L to be discharged in the balloon 10, the process of dropping the ballast is performed.

In the present embodiment, the discharging of the gas G into the air and the discharging of the liquid L into the air are performed; however, possible embodiments are not limited to this example, and it is acceptable to perform only the discharging of the liquid L into the air. That is to say, the abovementioned gas discharging mechanism (the gas discharge pipe 41 and the gas open/close valve 43) may be omitted, so that the flight height maintaining device 1 is only provided with the abovementioned liquid discharging mechanism (the liquid discharge pipe 42, the connection pipe 44, and the liquid pump 25). In the event that the gas G in the balloon 10 leaks into the air for some reason, it is expected that the buoyancy of the flight height maintaining device 1 may decrease, and the flight height Am may decrease. To cope with this situation, providing the flight height maintaining device 1 with the liquid discharging mechanism is sufficient. Using the liquid discharging mechanism to discharge the liquid L into the air makes it possible to increase the flight height Am of the flight height maintaining device 1.

In the present embodiment, the liquid L is contained in the balloon 10, together with the gas G; however, possible embodiments are not limited to this example. On the inside of the balloon 10, it is possible to physically partition between a space containing the gas G (hereinafter, “gas containing space”) and a space containing the liquid L (hereinafter, “liquid containing space”). In that situation, the gas discharge pipe 41 may be connected to the gas containing space and the liquid discharge pipe 42 may be connected to the liquid containing space.

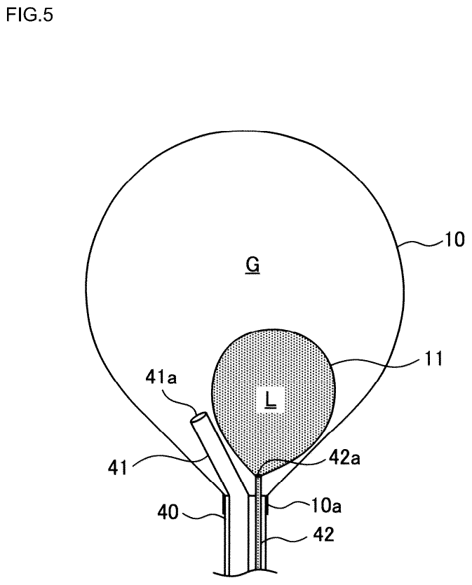

For example, as shown in FIG. 5, on the inside of the balloon 10, a container 11 for containing the liquid L may be disposed. FIG. 5 shows a part of the flight height maintaining device 1, and the structure omitted in FIG. 5 is the same structure as that in the embodiment described above.

The container 11 may be formed by using a stretchable/contractible material, so that the size of the container 11 may be changed in accordance with the contained amounts of the liquid L. Alternatively, it is also acceptable to allow the container 11 to maintain the size thereof, without letting the container 11 stretch or contract. By disposing the container 11 inside the balloon 10, the internal space of the container 11 may be used as a liquid containing space and the internal space of the balloon 10, excluding the container 11, may be used as a gas containing space.

In the gas containing space of the balloon 10, the gas suction port 41a of the gas discharge pipe 41 is positioned, so that the gas G contained in the balloon 10 is sucked into the gas discharge pipe 41 via the gas suction port 41a. The liquid suction port 42a of the liquid discharge pipe 42 is connected to the container 11, so that the liquid L contained in the container 11 is sucked into the liquid discharge pipe 42 via the liquid suction port 42a.

In the structure shown in FIG. 5, the gas containing space and the liquid containing space are physically partitioned by using the balloon 10 and the container 11; however, possible embodiments are not limited to this example. For instance, a partition part (not shown) may be provided inside the balloon 10, so as to divide the internal space of the balloon 10 into a gas containing space and a liquid containing space.

1. A flight height maintaining device comprising:
a balloon containing liquid and gas that generates buoyancy;
a payload unit attached to the balloon;
a liquid discharging mechanism that discharges the liquid in the balloon into air; and
a controller that controls an operation of the liquid discharging mechanism.

2. The flight height maintaining device according to claim 1, wherein
the liquid discharging mechanism includes:
a liquid discharge pipe having a liquid suction port for sucking the liquid in the balloon; and
a liquid pump that, upon receipt of a drive signal from the controller, generates suction force for causing the liquid discharge pipe to suck the liquid in the balloon.

3. The flight height maintaining device according to claim 2, wherein
the liquid suction port is positioned in a lower part of a region occupied by the liquid in the balloon.

4. The flight height maintaining device according to claim 1, comprising:
a height measuring device that measures a flight height of the flight height maintaining device, wherein
the controller brings the liquid discharging mechanism into operation, when the flight height measured by the height measuring device is lower than a prescribed height.

5. The flight height maintaining device according to claim 1 comprising:
a gas discharging mechanism that discharges the gas in the balloon into the air, wherein
the controller controls an operation of the gas discharging mechanism.

6. The flight height maintaining device according to claim 5, wherein
the gas discharging mechanism includes:
a gas discharge pipe that guides the gas in the balloon into the air; and
a gas open/close valve that, upon receipt of a drive signal from the controller, switches between a state in which a flow path for the gas in the gas discharge pipe is closed and a state in which the flow path is opened.

7. The flight height maintaining device according to claim 6, wherein
the gas and the liquid are contained inside the balloon in contact with each other,
the gas discharge pipe has a gas suction port for sucking the gas in the balloon, and
the gas suction port is positioned higher than an initial position of a liquid surface in the balloon.

8. The flight height maintaining device according to claim 5, comprising:
a height measuring device that measures a flight height of the flight height maintaining device, wherein
the controller brings the gas discharging mechanism into operation, when the flight height measured by the height measuring device is higher than a prescribed height.
